(19) United States
(12) Patent Application Publication
(10) Pub. No.: US 2015/0267430 A1
(43) Pub. Date: Sep. 24, 2015

(54) Exterior Leaf and Debris Filter for Swimming Pool Skimmers

(71) Applicant: Darrel Kemp, San Diego, CA (US)

(72) Inventor: Darrel Kemp, San Diego, CA (US)

(21) Appl. No.: 14/274,705

(22) Filed: May 10, 2014

Related U.S. Application Data
(60) Provisional application No. 61/954,816, filed on Mar. 18, 2014.

(51) Int. Cl. E04H 4/16; B01D 35/02

(52) U.S. Cl. CPC E04H 4/16; B01D 35/02

(57) ABSTRACT

An Exterior Leaf Filter that fits over the entrance from the pool to the skimmer compartment to keep leaves from accumulating in the skimmer basket, thus preventing restriction of the flow of water through the filtering system. This prevents wear or damage to the pool water pump and filters. An elastic strap is attached to an L-Shaped piece of plastic and to the Exterior Leaf Filter, pushed through the skimmer channel, and attached to the inner wall in the skimmer chamber holding the Exterior Leaf Filter in place. An optional plastic debris filter can be attached to the front of the leaf filter to filter debris.

### CROSS-REFERENCE TO RELATED APPLICATIONS

This application claims priority to provisional application No. 61/954,816 filed on Mar. 18, 2014.

### BACKGROUND OF THE INVENTION

Swimming Pools have a skimmer compartment (FIG. 1, E4 and FIG. 2, E4) with a skimmer basket (FIG. 2, E2) that slides into the skimmer compartment to filter out debris such as leaves, insects, etc. to keep them from getting into the pool filtering system. There is a opening in the side of a swimming pool (see FIG. 1, E1 and FIG. 2, E1) that forms a channel into the skimmer (referred to as the skimmer channel throughout this document) to allow water to flow from the pool into the skimmer compartment. This opening has a flap inside of it that helps prevent debris from flowing back into the pool. The skimmer compartment is a vertical circular cavity with piping at the bottom which connects to a water pump and continues on through a filter and then back into the pool through a separate opening. In the skimmer compartment is a skimmer basket (see FIG. 2, E2) that filters out the debris mentioned above from the water before it flows into a water pump and the swimming pool filter. This basket can be slid in and out of the skimmer compartment so the debris can be removed from it.

If the swimming pool is in an area where there are trees with large leaves such as those from sycamore trees that fall into the pool (especially in windy conditions), the skimmer basket will fill up restricting or even stopping the flow of water through the system. The restricted water flow puts a lot of strain on the water pump which shortens the life of the pump or may even burn it out (this leaf filter was invented because I have had 3 instances of the water pump burning out, and they are very expensive to replace). There is a need to filter these leaves in a way that will not restrict water flow.

### PRIOR ART

There have been numerous patents for skimmer filters (or guards or grilles as they have been commonly called). As can be seen from reviewing these prior patents, finding an easy way to attach the guards has been a concerted effort over a long period of time. Most in the past have used hooking methods such as screwing screws into the side of the pool to attach a face plate to the side of the pool for the guard to snap onto, which requires a permanent modification of the pool. There are more recent patents with a mounting system that slides into the skimmer channel using friction or snaps to hold it in place. There are several limitations to all of these. They are required to be a certain size to slide into the skimmer channel opening. All skimmer channels are not the same size, especially in many of the existing pools such as Gunite Pools (a cement type of material) with plaster. This is especially true if the pool has been re-plastered. The channel size may not be built the same size and tile or other decorative material may have been added to the channel altering its size. They also are restricted to the location of the skimmer channel that they slide into. This channel may be only 1⅜″ below an overhang over the wall of the pool which is the case in our pool and many others constructed in our area. This may prevent them from having room to slide into the channel. It also limits the filter (or guard or grille) to the size of the channel opening and requires the filter, guard, or grille to be flush with the side of the pool. A filter flush against the side of the pool only the size of the skimmer channel opening can get clogged just like the skimmer basket, especially if the water level is at the bottom of the channel. One last problem that may be encountered is it may interfere or run into the flapper mounted inside the skimmer channel.

The attaching system discovered and used in this patent application may end the quest to create an easy and universal way of attaching guards, filters, grilles, or closing systems. The attachment system being patented in this patent application uses elastic cords and an L-shaped piece of plastic that you simply slide through the skimmer channel and hook over the inside wall of the skimmer compartment. This eliminates the need for the attaching device to be a correct size to slide into the skimmer channel and the need to make any modifications to the pool. It also overcomes the need for the filter or guard mounting system to be the same size as the channel opening and for the guard or grille to be flush against the side of the pool.

The filter in this patent can be any size with the entire filter having openings. The larger surface can simply be placed against the pool wall, slid over the skimmer channel opening, and attached using the elastic cords. It also makes it possible for the filter to have sides that raise the flat part of the filter away from the side of the pool. This creates a much larger area for the water to flow through when entering the skimmer channel so that water flow is always assured. The filter will extend below the bottom of the skimmer channel so that even if the water level gets low enough to be only as high as the bottom of the skimmer channel, water will still flow because the filter openings extend below the bottom of the skimmer channel. With this filter system that is larger than the skimmer channel opening and that extends below the bottom of the skimmer channel, leaves will not get clogged restricting water flow. Leaves and debris tend to sit on top of the water or drop to the bottom, so they will not accumulate on the part of the filter that extends below the surface of the water.

These are points to be kept in mind while reviewing the prior art below or any other prior art that may be discovered in the USPTO search.

1. U.S. Pat. No. 7,291,260 dated Nov. 6, 2007

This patent requires that the pool be modified by screwing a frame to the side of the pool around the opening of the skimmer channel (FIG. 1). A flat cover with openings in it attaches to this frame without the use of tools by sliding onto screws that protrude from the frame. They slide on it much like a picture frame slides onto a nail.

The first problem with this system is the pool has to be modified by screwing a frame into the side of the pool over the skimmer channel opening. The pool would have to be drained enough for this frame to be attached. Since the openings into skimmer channels are not always the same shape or size, especially if the pool has to be re-plastered or re-tiled, this frame may need to be modified for different sized skimmer entrances and shapes.

Another problem with the guard in this patent is that it uses a flat screen the size of the entrance to the skimmer that sits flat against the entrance or the frame. This flat screen can get clogged with larger leaves just like the skimmer basket.

As discussed above, the external leaf filter being patented here corrects all of these problems. It has a filter that is much larger than the channel opening with sides and bottoms that so it is raised away from the side of the pool. This creates more area for water flow and will keep the filter from getting clogged since leaves do not tend to accumulate against the part of the surface below the water line. It requires no modification of the pool. It will universally fit any skimmer channel because the filter or grille is larger than the channel opening and is simply slid over the opening and secured by attaching the elastic cords to it.

2. U.S. Pat. No. 7,195,708 dated Mar. 27, 2007.

This skimmer guard also has a flat screen attached to a box shaped frame that slides into the skimmer channel using friction and needs no tools or modifications to the pool. It can also attach to a flange if the pool happens to have one.

One problem with this system is that openings to skimmer channels are not all the same size or shape, so it is not universal. Also, the size of the opening to the skimmer may change when the pool is re-plastered, tiled, or re-tiled with different tile. In our pool, bricks or stone may overhang the edge of the pool. The gap between the bottom of the bricks and the top of the opening to the skimmer channel is only 1⅜″. In either case, the skimmer guard in this patent would not fit. It would have to be modified, which would mean making it custom for many skimmer channels making mass production difficult.

Another problem with this patent is it has a flat screen the size of the opening to the skimmer and would get clogged in the case of excessive large leaves just like the skimmer basket gets clogged

As discussed above, the leaf filter being patented in this patent application will universally fit any skimmer channel, and the shape and size of the filter will prevent it from getting clogged.

3. U.S. Pat. No. 6,214,217 dated Apr. 10, 2001

The main problem with this system is it requires modification of the pool for a mounting bracket to be securely attached to the pool wall using a complicated fastening system. It is also pretty complicated and not very attractive. Even though they claim in the patent that it is made to be cheaply manufactured and that size differences are obvious, size differences mean that one universal unit could not be produced. This complicates the manufacture and marketing of the product since different size units would have to be manufactured to suit different size and shaped skimmer openings.

The external leaf filter being patented here does not require any modification to the pool and will universally fit any skimmer channel.

4. U.S. Pat. No. 5,285,538 dated Feb. 15, 1994 is for a device that seals off the skimmer in the off season and does not address filtering the water during periods when the pool is in use as discussed in U.S. Pat. No. 7,291,260. It also requires modification of the pool to mount a face plate and has the same limitation as the above discussed patents.

With the attaching system being patented here, a solid piece that is larger than the skimmer channel opening with a rubber seal could be slid over the skimmer channel opening and attached using the elastic cords. As can be seen again, the attaching system allows for any type of surface to be attached over the skimmer channel opening.

5. U.S. Pat. No. 4,140,634 dated Feb. 20, 1979.

The problem with this system is that it requires modification of the pool to attach a support frame through use of hooks and bolts to be screwed into the pool for mounting the filter. It is complicated and requires the use of tools to attach or remove the screen to or from the frame.

In the case that the pool is not suitable for the hooks to be screwed in, hooks with suction cups are listed as an option. There is a significant chance that the suction cups will fall off and would not give the user confidence the unit would stay attached rendering it useless. Some of the patents above were improvements to this patent.

### BRIEF DESCRIPTION OF THE DRAWINGS

The figures are for demonstrating the system and are not meant to be exactly proportional.

FIG. 1 shows the skimmer channel opening (E1), the skimmer chamber (E4), and the top that fits over the skimmer chamber (E5).

FIG. 2 is a cut away side view of the skimmer system (skimmer channel E1, skimmer compartment E4, and skimmer basket E2 inside the skimmer compartment). It also shows the system mounted with the filter P1 against the side of the pool over the skimmer channel and the mounting system (P2, P3) running through the skimmer channel and the plastic L-shaped piece of plastic (P3) slid onto the inside wall of the skimmer channel.

FIG. 3 is a view of the leaf filter used in the prototype built and used as a model for this patent.

FIG. 4 is the leaf filter with plastic mesh attached to it using plastic fasteners (stay put fasteners were used in the figures) that slide in and out of holes in the side of the leaf filter. The mesh can then be quickly removed and re-attached in seconds simply by sliding the stay put fasteners through the holes in the leaf filter and opening and closing the securing swivels. The mesh can have different sized holes which will allow the leaf filter to filter smaller leaves or become a debris filter if the holes are the same size as the holes in the skimmer basket.

FIG. 5 shows the unique attaching system with a L-shaped piece of plastic with the flexible elastic cords hooked to it.

FIG. 5A shows one of the elastic cords with hooks at each end (P2) that is to be attached to the L-shaped piece of plastic (P3) and to the leaf filter. This combo is referred to as the “attaching system” throughout this patent application.

FIG. 6 shows the leaf filter (P1) attached to the elastic cords (P2) which are attached to the L-shaped piece of plastic (P3) being slid onto the skimmer channel.

FIG. 7 shows leaf filter resting against the pool wall underneath the brick overhang with the attachment system holding it in place. E7 is the brick overhang and E6 is the tiled side of the pool. There is 1⅜″ between the bottom of the bricks and the top of the skimmer channel in this example.

FIG. 8 shows plastic mesh that can be placed over the front and sides of the leaf filter. The mesh has plastic stay put fasteners attached to it that are slid through holes in plastic pieces attached to the sides of the leaf filter and secured. An example of stay put fasteners can be seen online at stayputfasteners.com, but any type of plastic fastener can be used. Once the mesh (which will have different sized holes than the leaf filter) is slid over the front and sides of the leaf filter and secured, the size of the leaves being filtered can be adjusted easily without having to make different leaf filters. If the holes are made smaller like the size of the holes in the skimmer basket, the leaf filter is converted into debris filter. This system allows the size of the filtering holes to be adjusted in seconds.

FIG. 9 shows the plastic fasteners (stay put fasteners are used for the prototype) on the plastic mesh extending through the holes in one of the plastic pieces attached to the leaf filter. The mesh is secured by simply pushing the plastic swivel that is part of the stay put fasteners to the closed position. This system allows for the plastic mesh to be placed on the leaf filter and removed in seconds, making it totally convertible quickly without buying different leaf filters with different sized holes.

### LISTING OF PARTS

There are 2 types of labeling for the parts listing. P+a number is parts used in the invention and E+a number is explanations, examples, and parts in the description not used to make the invention. The parts in this listing are the ones used to make a prototype of the invention to test and develop it. The sizes are not fixed.

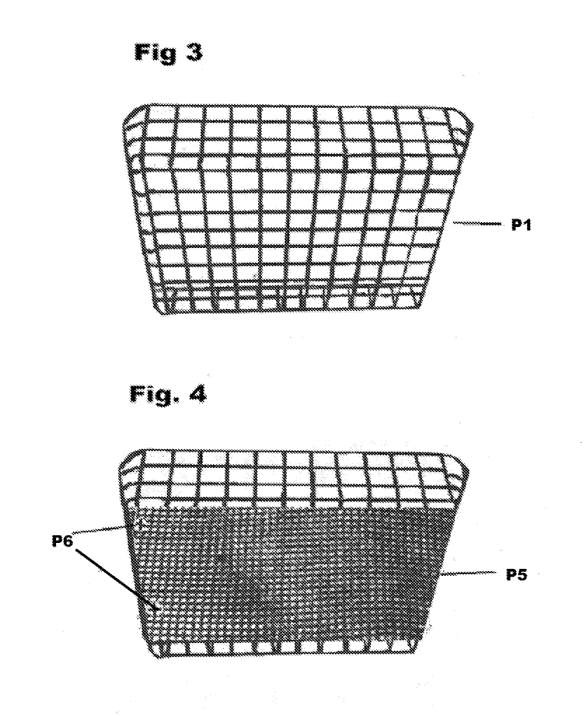

P1—(FIG. 3) A box shaped unit made of plastic with holes in it (referred to as the Leaf Filter in this document) that will sit against the wall of a swimming pool over the skimmer channel to filter out leaves and, if desired, debris. It has sides so that the flat piece of the filter does not rest flush against the side of the pool.

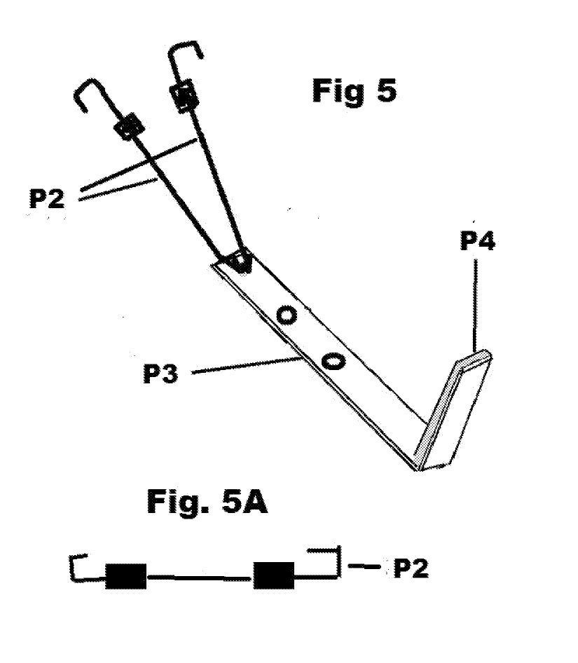

P2—(FIG. 5) Two elastic cords with rubber hooks that attach to an L-shaped piece of plastic (this combo makes up what is called the “attaching system” in this document).

P3—(FIG. 5) The L-shaped piece of plastic to which the elastic cords are attached that slides through the skimmer channel and is hooked to the inside of the skimmer compartment.

P4—(FIG. 5) A piece of foam attached to the part of the L-shaped piece of plastic on part P3 rests against the inside of the skimmer basket to keep it from sliding off. See FIG. 5.

P5—(FIG. 4,8) A piece of plastic mesh with holes in it that can be slid over the leaf filter which allows for the size of the leaves being filtered to be changed. It also allows for the leaf filter to be converted to a debris filter.

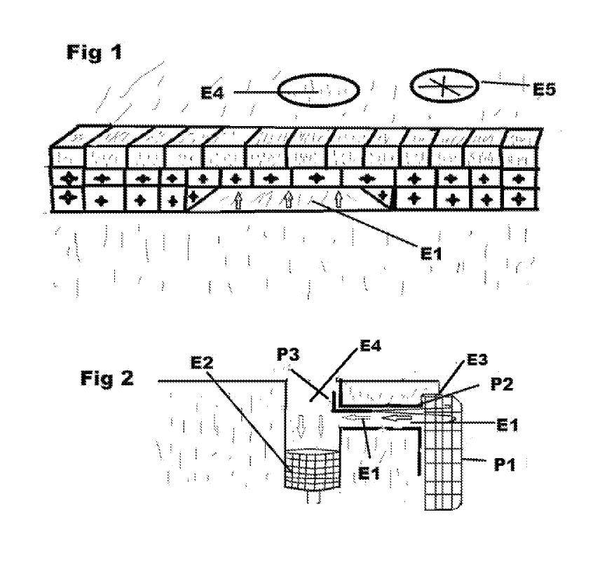

P6—(FIG. 9) Plastic fasteners used to secure the plastic mesh to the leaf filter. E1—(FIG. 1) The skimmer channel which allows water to flow from the pool into the skimmer compartment.

E-2—(FIG. 2) A basket with small holes in it that sits in the bottom of the skimmer compartment to filter debris and keep the debris from getting to the pool pump.

E3—(FIG. 2) An example of how the leaf filter fits under the bricks and against the pool wall for the pool used to develop the prototype used in the drawings in this patent application. The bricks in the figures used in this application protrude over the pool wall so the skimmer channel is recessed under them. The distance from the bottoms of the bricks and the top of the skimmer channel is only 1⅜″.

E4—(FIG. 2) The skimmer compartment which is a barrel shaped cylinder with the skimmer basket sitting in the bottom of it. It is hooked at the bottom to piping that continues to the pool pump, a large filtering compartment, and back to the pool.

E5—(FIG. 1) A top that fits over the skimmer compartment.

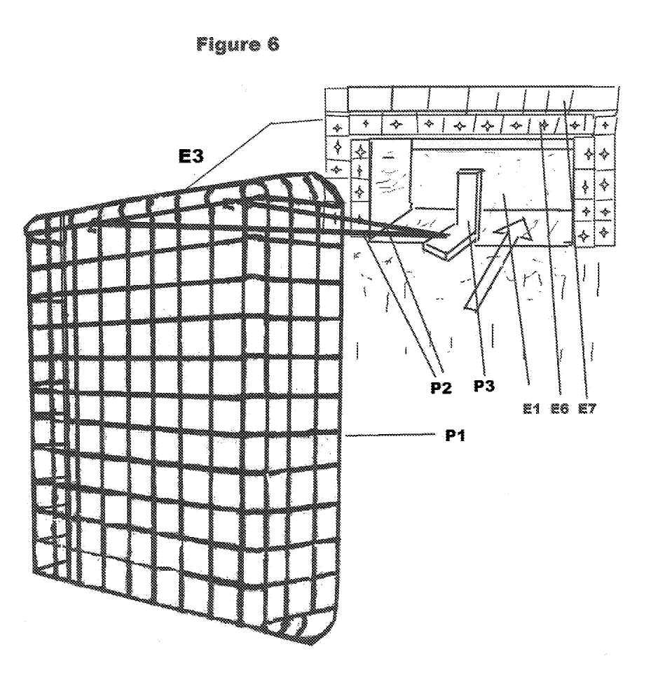

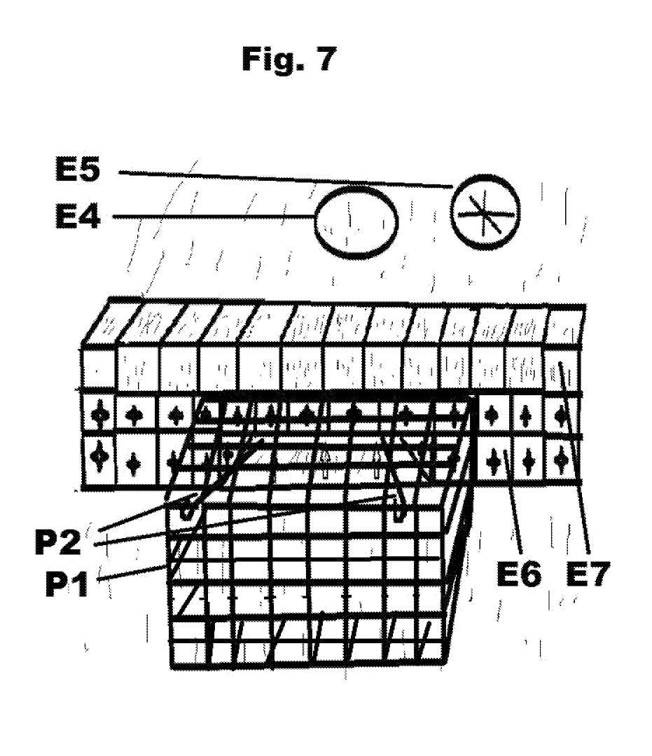

E6—(FIG. 6) Points to the tiled side of the pool which has the skimmer channel in it.

E7—(FIG. 6) Points to the bricks that create the overhang in the pool used in the figures.

### SUMMARY OF THE INVENTION

The invention is a filter designed to keep large leaves and other large items from entering a swimming pool skimmer channel and the skimmer basket. It is easily converted into a filter for smaller items and debris by simply attaching a separate plastic mesh filter that quickly attaches to the filter using plastic fasteners. The unique attaching system allows the leaf filter to universally fit over all skimmer channels. Because of the attaching system, the filter can be larger than the skimmer channel opening and extend below the bottom of the skimmer channel. If constructed with sides so the flat surface of the filter does not rest against the pool wall, there is more area with openings for water flow. It will not get clogged because leaves and debris will either float against the filter on the surface of the pool or sink to the bottom and not rest against the filter surface below the water line. Also, there are plenty of openings below the surface of the pool and below the bottom of the skimmer channel that will allow water flow, unlike existing systems where the surface is the size of the skimmer opening.

### DETAILED DESCRIPTION OF THE INVENTION

This invention consists of a square or rectangular shaped filter which has sides (FIG. 3). It can be any size, but the one used as a prototype for development of the filter system and demonstrated in this patent application is approximately 30″ wide and tall with 4″ sides. The holes used in the examples in the drawings are approximately 11/2″ in size. The filter could be larger or smaller, the sides could be taller or shorter and the holes could be smaller or larger. With the mesh system that goes over the leaf filter (FIG. 4) which is described below, larger openings could be used and adjusted down to smaller opening if the pool owner had a need to filter out more items before they enter the skimmer basket. This mesh system is another feature that makes the filter system being patented universally meet the needs of all pool owners and eliminates the need to manufacture different types and sized equipment for different needs.

The leaf filter is attached to the side of the pool using an attaching system that consists of two elastic cords with hooks at each end that are attached to an L-shaped piece of plastic (FIG. 5).

One end of the elastic cords is attached to the upper portion of the leaf filter and the other end to the L-shaped piece of plastic. The L-shaped piece of plastic is pushed through the skimmer channel and hooked over the upper inside wall of the skimmer compartment (FIG. 2 and FIG. 6). This stretches the elastic cords so the leaf filter is held in place. The L-shaped piece of plastic will not slip off of the inside wall of the skimmer because of the foam or rubber that is attached to the portion of the L-shaped piece of plastic that rests against the skimmer wall. The elastic straps are attached to the leaf filter and inside wall of the skimmer compartment near the top so the elastic straps and L-shaped piece of plastic run along the top of the skimmer channel so as not to interfere with the functioning of the flapper in the skimmer channel.

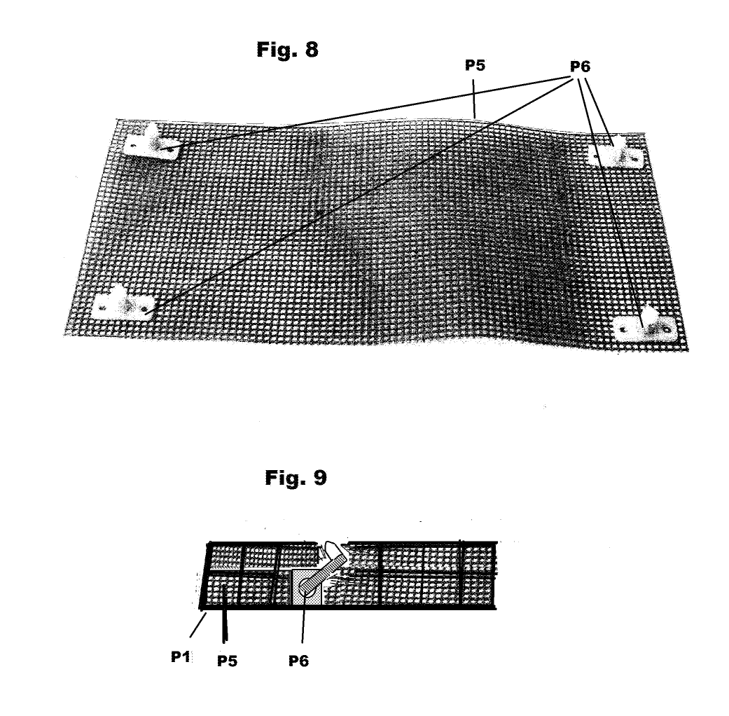

The plastic mesh can be attached to the front and sides of the filter simply by wrapping it over the front of the filter and inserting the plastic fasteners through the holes in the plastic pieces attached to the sides of the filter (FIGS. 8 and 9). This mesh system allows the filter to be adjusted to filter whatever sized debris is desired by the pool owner.

If constructed with sides so the flat surface of the filter does not rest against the pool wall, the filter will not get clogged because leaves will either float against the filter on the surface of the pool or sink to the bottom. This leaves plenty of openings below the surface of the water that will allow water flow. Another reason the filter will be much less likely to clog in this instance is that there is a lot more surface unlike existing systems where the surface is the size of the skimmer opening.

How the Exterior Leaf and Debris Filter for Swimming Pool Skimmers is Constructed

All of the parts for the prototype built to develop and demonstrate this Leaf Filter system were purchased. The basket used as the filter was purchased at a thrift store, the elastic bungee cords used as the elastic cords were bought at a home improvement store, the L-shaped piece of plastic was purchased at a Bed and Bath type of store and cut to the size needed for this filter system, and the stay put fasteners were bought at a marine supply store. If a company that manufactures skimmer baskets or skimmer guard systems produces this product, they will probably manufacture the parts.

How The Invention Works:

The invention works by pushing the L-shaped piece of plastic that is attached to the elastic cords and the top of the filter through the skimmer channel and attaching the part of the L-shaped piece of plastic to the upper inside of the skimmer compartment (FIG. 2). The tension created by the elastic cords holds the filter in place over the skimmer channel.

Uses for the Invention:

The invention can be used to filter large objects such as thermometers or floating lights from entering the skimmer basket. It also filters out large leaves such as the large leaves from a sycamore tree without getting clogged. It can also be adjusted with the use of a plastic mesh cover that goes over the filter and quickly attaches to the filter using plastic fasteners to filter out smaller leaves or debris. The system could be sold with more than 1 mesh screen, each having different sized holes. The system could be used to close off the skimmer system in the winter by having an accessory that is a solid piece of plastic with a rubber seal around it that is simply slid over the skimmer channel opening and attached using the universal attaching system being patented. With the attaching system, anything that is to be put over a skimmer channel opening will universally fit over the opening making the system capable of meeting many needs, even needs not covered above.

1-7. (canceled)

8. I claim a device that consists of a leaf and debris filter and a quick attachment and removing mechanism that attaches to the top portion of the filter and is slid through a skimmer channel and hooked over the upper inside wall of the skimmer channel thus securing the filter in place over the skimmer channel.

9. The leaf and debris filter in claim 8 has a rectangular or square shaped surface with sides that give it an inner depth so the surface will be raised when it rests against another flat surface such as the side of a swimming pool, the surface being of a size larger than the outer edges of skimmer channels it is to be attached to, thus allowing the leaf and debris filter to fit over any sized skimmer channel smaller than the size chosen for the leaf and debris filter.

10. The leaf filter set forth in claim 9 has a proliferation of openings large enough to allow unrestricted water flow through it into the skimmer system, the openings being small enough to filter out larger items such as large leaves, thermostats, or toys.

11. The leaf filter with openings set forth in claim 10 has an optional attachment consisting of a thin surface designed to fit over the face and the sides of it, the surface of the attachment having a proliferation of openings that are smaller than the ones in the leaf and debris filter set forth in claim 10, the attachment being attached to the leaf and debris filter using quick release fasteners, the attachment thus filtering out smaller leaves and debris than the ones filtered by the leaf filter when the mesh is not attached.

12. The quick release attaching mechanism as set forth in claim 8 consists of elastic cords with hooks at both ends and an L-shaped piece of plastic, the elastic cords are attached to the L-shaped piece of plastic and to the filter, the L-shaped piece of plastic and the elastic cords are slid through the skimmer channel, the L-shaped piece of plastic is then hooked over the upper inner wall of the skimmer channel thus attaching the leaf and debris filter over the skimmer channel.

13. The elastic cords in claim 12 that that are slid through the skimmer channel can be attached to the inner wall of the skimmer channel using attaching techniques other than the L-shaped piece of plastic set forth in claim 12.

14. The unique attaching system set forth in this patent application can be used for attaching any device that is designed to go over a skimmer channel such as a filter, grille, flat piece of plastic, etc.
